(19) United States
(12) Patent Application Publication
(10) Pub. No.: US 2010/0251017 A1
(43) Pub. Date: Sep. 30, 2010

(54) Soft error processing for multiprocessor

(75) Inventors: Tetsuya Yamada, Sagamihara (JP); Makoto Ishikawa, Kodaira (JP); Masashi Takada, Kokubunji (JP); Hiromichi Yamada, Hitachi (JP)

Correspondence Address: MILES & STOCKBRIDGE PC, 1751 PINNACLE DRIVE, SUITE 500, MCLEAN, VA, 22102-3833, US

(73) Assignee: RENESAS TECHNOLOGY CORP.

(21) Appl. No.: 12/721,208

(22) Filed: Mar. 10, 2010

(30) Foreign Application Priority Data
Mar. 27, 2009 (JP) 2009-080010

(51) Int. Cl. G06F 11/14; G06F 12/08

(52) U.S. Cl. 714/15; 711/119; 711/E12.017; 714/E11.117

(57) ABSTRACT

The data processor having CPUs each capable of accessing memories enables the processing of a memory error according to the processing mode of the data processor. The CPUs have a memory, and each include a first storing unit capable of storing CPU-identifying information which enables identification of CPU having accessed the memory. At the time of occurrence of a soft error owing to access to the memory, the CPU, having the memory, stores the CPU-identifying information for identifying the CPU having accessed the corresponding memory in the first storing unit, and notifies the interrupt controller of occurrence of a soft error of the memory. After having received an interruption of the memory soft error from the interrupt controller, the CPU uses information stored in the first storing unit to identify the CPU having made the access, and performs the error processing.

### CLAIM OF PRIORITY

The Present application claims priority from Japanese application JP 2009-080010 filed on Mar. 27, 2009, the content of which is hereby incorporated by reference into this application.

### FIELD OF THE INVENTION

The present invention relates to a soft error processing technique for a data processor, and more particularly to a technique useful in application to a microprocessor including a memory with a mechanism for detecting a memory error using ECC (Error Correcting Code), a parity or the like, and having a plurality of CPUs (Central Processing Units).

### BACKGROUND OF THE INVENTION

The advancement of semiconductor technologies has promoted the scaling down of semiconductors, and consequently a microprocessor including two or more CPUs and functional blocks has been developed. However, the influence of a malfunction particularly attributed to a soft error of a memory becomes more significant. A soft error is caused by cosmic radiation made up of primarily alpha and neutron rays destructing the content of a memory cell. Unlike a hard error, a soft error is not a permanent fault, but a transient fault, and therefore it is possible to correct the content of a memory cell. In regard to soft errors, it is common to add a function making use of a parity for detecting an error or a function making use of ECC (Error Correcting Code) for detecting and correcting an error to a memory.

Thanks to the rise in the integration resulting from the scaling down of semiconductor devices, a microprocessor with a plurality of CPUs has many memories incorporated therein, and such memories include a primary RAM (Random Access Memory) or primary cache of each CPU, a secondary RAM or secondary cache used as a shared memory, and ROM (Read Only Memory). Therefore, it is required for achievement of a highly-dependable microprocessor to implement, on each memory, a function making use of a parity or ECC. In regard to a microprocessor having a plurality of CPUs and a plurality of memories, how to detect and correct a memory error is important for increasing the reliability.

Japanese Unexamined Patent Publication No. JP-A-2000-099406 discloses, as means for processing a parity error on a primary cache memory—one of memories for CPU, the notification of the parity error by interruption, and the nullification of a cache line. On detection of a parity error of a cache memory, an interruption is caused to notify the operating system of that. Then, a reference is made to an interrupt status register from software. Thus, it can be confirmed that the interruption results from the parity error. Such interruption is in synchronization with an instruction, and therefore, in the event of the interruption, the execution of preceding instructions have been completed, and the implementation of the following instruction is suspended. The data for the instruction having caused the parity error has been stored by the program counter, and whether to complete or stop the instruction can be selected depending on the type of the interruption. If the line of the cache memory with the parity error caused therein conforms to the content of the memory, a process for nullifying the cache line is performed.

With regard to a microprocessor having a plurality of CPUs and a plurality of memories and arranged so that the CPUs work on a common operating system (OS), International Patent Publication No. WO2006/082657 discloses the recording of error information as means for handling a hard error. In case that a hard error takes place in a microprocessor with CPUs working on a common OS, the CPU with the error caused or other normal CPU not concerned in the error records the error information, performs the synchronous processing of the file system, and acquires a memory dump, and then again activates the system, following the operating system. In the error information, the CPU number of CPU with an error caused, and the address of data associated with the error are contained. In notification to other CPU, a shared memory is used for inter-CPU communication.

### SUMMARY OF THE INVENTION

JP-A-2000-099406 discloses a method of processing a memory error using an interruption for a parity error of the primary cache. However, it does not disclose a method of processing a memory error involved in the plurality of CPUs and the plurality of memories.

WO2006/082657 discloses a method for processing a memory error in a microprocessor with the plurality of CPUs and the plurality of memories working on a common operating system. Even though the memories of the processor include memories that the CPUs have respectively, and a shared memory for communication between the CPUs, the Patent Publication No. WO2006/082657 targets the processing of a memory error on the memory belonging to each CPU in disregard of the processing of a memory error on the shared memory. Because the memory specific to each CPU is targeted, the CPU number of memory error information at the time of the occurrence of a memory error is always the number of CPU having its own memory.

A multiprocessor having the plurality of CPUs has two processing modes, i.e. AMP mode (AMP: Asymmetric Multi-Processing) and SMP mode (SMP: Symmetric Multi-Processing).

Adopted for the Asymmetric Multi-Processing is a parallel processing technique by which each CPU has an independent memory space, and processes are statically allocated on an individual CPU basis. A processing form such that one CPU is connected through a plurality of buses, and the CPUs work on respective operating systems is classified as AMP.

Adopted for the Symmetric Multi-Processing is a parallel processing technique by which two or more CPUs share a memory space, and processes are dynamically allocated to the CPUs so that the CPUs are evened in processing load. When a process is carried out, the following procedure is taken. That is, an operating system for SMP divides the shared memory space into processing units referred to as “threads”, and assigns the threads to the CPUs so that the CPUs are evened in processing load.

With regard to a data processor, such as a multiprocessor having a plurality of CPUs and a plurality of memories and arranged so that a plurality of operating systems work on the CPUs, the inventor examined a method of processing memory errors on a built-in memory that each CPU has, and a shared memory. As a result, the inventor found that it is necessary to treat a memory error according to a processing mode in a data processor such as a multiprocessor.

The Patent Publication No. WO2006/082657 discloses a memory error on memories that CPUs have individually on condition that a common operating system work on the CPUs. However, turning to the above-described processing modes, a case that different operating systems run on the CPUs is left out of consideration.

Therefore, it is an object of the invention to provide a technique for a data processor including a plurality of CPUs capable of accessing respective memories, which enables the processing of an memory error according to the mode of processing by the data processor.

The above and other objects of the invention and a novel feature thereof will become clear from the description hereof and the accompanying drawings.

Of embodiments disclosed therein, representative one will be briefly outlined below.

According to an embodiment of the invention, a data processor including a plurality of CPUs each having a memory, in which the CPUs each have a first storing unit (CPUID) capable of storing CPU-identifying information which makes possible to identify the CPU having accessed the memory. If a soft error occurs at the time of accessing a memory, the CPU, having the memory, stores CPU-identifying information for identifying the CPU having accessed the corresponding memory in the first storing unit, and notifies the interrupt controller (30) of occurrence of the soft error on the memory. After having accepted, from the interrupt controller, an interruption resulting from a soft error on the memory, the CPU uses the stored information in the first storing unit to identify the CPU having made the access, and makes an arrangement for conducting the error processing.

The effect achieved by the representative embodiment of the invention herein disclosed will be described below in brief.

An adequate error processing can be performed according to information for identifying the CPU having accessed a memory. Therefore, as to a data processor having a plurality of CPUs and a plurality of memories, a memory error can be processed according to the processing mode of the data processor.

### BRIEF DESCRIPTION OF THE DRAWINGS

FIG. 1 is a block diagram showing an example of the configuration of a microprocessor, which is an embodiment of a data processor according to the invention;

FIG. 2 is a diagram for explaining a process carried out when a memory error is caused in the microprocessor;

FIG. 3 is a diagram for explaining the case that a memory access by CPU causes a memory error in the microprocessor;

FIG. 4 is a diagram for explaining the case that a memory error of a duplicated tag occurs in CPU in the microprocessor;

FIG. 5 is a block diagram showing an example of the configuration of a duplicated tag memory (DAA) included in the microprocessor;

FIG. 6 is a first diagram for explaining the case that a memory error occurs with CPU according to Symmetric Multi-Processing on condition that mutually different operating systems work in the microprocessor; and

FIG. 7 is a second diagram for explaining the case that a memory error occurs with CPU according to Symmetric Multi-Processing on condition that mutually different operating systems work in the microprocessor.

### DETAILED DESCRIPTION OF THE PREFERRED EMBODIMENTS

### 1. Brief Description of the Preferred Embodiments

First, the preferred embodiments of the invention herein disclosed will be outlined. Here, the reference characters and numerals to refer to the drawings, which are accompanied with paired round brackets, only exemplify what the concepts of parts or components referred to by the characters and numerals contain.

[1] A data processor (10) according to a preferred embodiment of the invention includes: a plurality of CPUs (200-203) each accessible to respective memories (L1C, RAM1, RAM2); and a first storing unit capable of storing CPU-identifying information which enables identification of the CPU having accessed the memory. The stored information of the first storing unit is used for error processing to cope with a soft error of the memory. The CPU-identifying information includes ID information such as a CPU number assigned to each CPU.

[2] The data processor as described in [1] may include an interrupt controller (30) operable to accept an error notification corresponding to a soft error, and to assert an interrupt signal according to a predetermined priority order. In regard to the data processor, the CPU may be arranged so that information of an address where the soft error of the memory concerned occurs is stored in the first storing unit when the CPU receives an interruption resulting from the soft error on the memory from the interrupt controller.

[3] In the data processor as described in [2], the interrupt controller includes a function of inter-CPU interruption according to software setting. The interrupt controller may be arranged so that when identification information of the CPU controlling the memory differs from the CPU-identifying information stored in the first storing unit, the interrupt controller issues an inter-CPU interruption, thereby to notify the CPU corresponding to the CPU-identifying information stored in the first storing unit of occurrence of the soft error on the memory.

[4] The data processor as described in [2] may include a shared memory (50) shared by the plurality of CPUs, and a control circuit (40) capable of controlling the shared memory in operation may be provided. Further, the control circuit may include a second storing unit capable of holding an address where the soft error of the memory occurs, and identification information of the CPU having accessed the shared memory in case of occurrence of a soft error of the shared memory. The data processor may be arranged so that when notified from the control circuit of a result of detection of a soft error of the shared memory, and identification information of the CPU involved with memory access, the interrupt controller issues a soft error interruption of the memory to the CPU corresponding to the relevant identification information.

[5] The data processor as described in [2] may further include a duplicated tag memory (211). With the data processor, each CPU may be provided with a primary cache (L1C), and the duplicated tag memory is capable of storing a copy of a tag of the primary cache. Further, the data processor is arranged so that the duplicated tag memory can be updated when an access to the primary cache is made. Also, the data processor may be arranged so that identification information of the CPU involved with access to the primary cache, tag information of the primary cache, and a flag bit corresponding the duplicated memory are set in the first storing unit in the CPU operable to control the primary cache in case of occurrence of a memory error on the duplicated tag memory.

[6] The data processor as described in [2] may include a secondary cache; and a control circuit capable of controlling the secondary cache. Further, the secondary cache control circuit may include a third storing unit capable of holding an address where a soft error of the memory concerned occurs, and identification information of the CPU having accessed the memory in case of occurrence of a soft error of the memory. In this form, the data processor may be arranged so that when notified of a result of detection of a soft error of the secondary cache, and identification information of the CPU involved with access to the secondary cache, the interrupt controller issues a soft error interruption of the memory to the CPU corresponding to the CPU identification information.

[7] The data processor as described in [2] may further include: a secondary cache; and a control circuit capable of controlling the secondary cache. Further, the secondary cache control circuit may include a third storing unit capable of holding an address where a soft error of the memory concerned occurs, and identification information of the CPU having accessed the memory in case of occurrence of a soft error of the memory. On condition that at least two of the plurality of CPUs are identical to each other in operating system on which the at least two CPUs work according to Symmetric Multi-Processing, and in case of occurrence of a soft error owing to access to the secondary cache by one of the at least two CPUs, the interrupt controller may be arranged so that the following actions are performed.

That is, in case of occurrence of a soft error owing to access to the secondary cache by one of the at least two CPUs, the interrupt controller issues a soft error interruption of the memory to the at least two CPUs all at once, on receipt of notification of a result of detection of a soft error of the secondary cache, and identification information of the CPU involved with access to the secondary cache.

### 2. Further Detailed Description of the Preferred Embodiments

The embodiments will be described further in detail.

It is noted that as to all the drawings to which reference is made in describing the embodiments for carrying out the invention, the constituents or elements having identical functions are identified by the same reference numeral, and the iteration of description thereof is omitted herein.

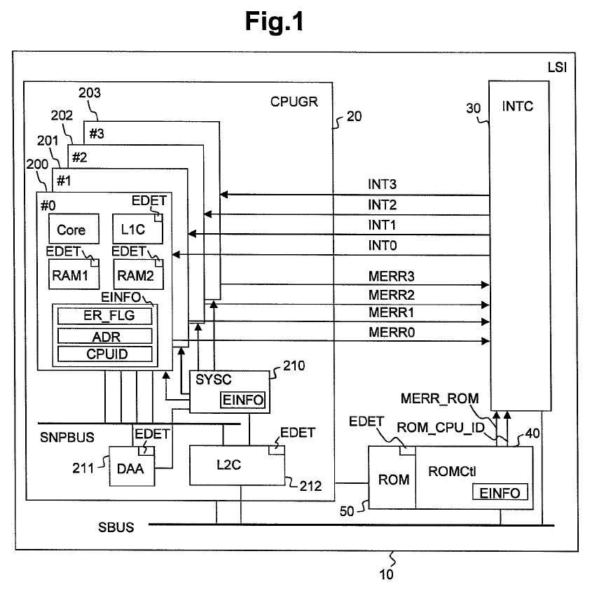

FIG. 1 shows a microprocessor as an example of a data processor in connection with the invention.

Although no special restriction is intended, the microprocessor (LSI) 10 shown in the drawing is formed in a semiconductor substrate such as a substrate of monocrystalline silicon by a known semiconductor IC manufacturing technique. Further, the microprocessor 10 includes: a CPU group (CPUGR) 20 composed of more than one CPU; an interrupt controller (INTC) 30; and a ROM (Read Only Memory) 50 with a ROM control unit (ROMCtl) 40. However, it is not so limited particularly. The CPU group (CPUGR) 20, interrupt controller 30, and ROM 50 are coupled so that they can exchange signals through a system bus (SBUS) mutually.

The CPU group 20 is not particularly limited, however it includes four CPUs 200, 201, 202 and 203, a system controller (SYSC) 210, a secondary cache (L2C) 212, and a duplicated tag memory (DAA) 211, which are connected through a snoop bus (SNPBUS) mutually. The four CPUs 200, 201, 202 and 203 are identical with one another in structure, and they are identified by CPU numbers (ID numbers) #0, #1, #2 and #3, respectively. For instance, CPU 200 labeled with #0 includes: a CPU core (Core) forming the kernel of the CPU; a primary cache (L1C); a built-in SRAM1 (RAM1); a built-in SRAM2 (RAM2); an error-information-holding circuit (EINFO). The CPU core (Core) executes a predetermined operation process according to a preset program. The CPU core attempts to read the primary cache (L1C), first. If the primary cache (L1C) holds no data, the CPU core attempts to read the secondary cache (L2C) 212, which is lower in reading rate and larger in capacity in comparison to the primary cache (L1C). The built-in SRAM1 (RAM1) and built-in SRAM2 (RAM2) are used as working areas for an operation process in the CPU. The memories on which the detection of a memory error is required are each provided with a memory-error-detecting circuit (EDET) operable to detect a memory error. The memory-error-detecting circuit (EDET) detects a read data error by means of e.g. ECC error detection or parity error detection, basically. The error-information-holding circuit (EINFO) holds error information. Although no special restriction is intended, the error-information-holding circuit (EINFO) includes an error-flag register (ER_FLG) for holding an error flag, an error-address register (ADR) for holding an error address at the time of occurrence of a memory error, and an access-CPU-number register (CPUID) for holding a CPU number showing which CPU has made a memory access resulting in a memory error. Such error-information-holding circuit (EINFO) is also provided in the system controller (SYSC) and ROM control unit 40.

The CPUs 200 to 203 supply the interrupt controller 30 with a memory-error-notice signal (MERR0-MERR3) for notifying the controller of a memory error. The interrupt controller 30 provides a memory-error-interrupt signal (INT0-INT3) to the CPUs 200 to 203. Further, the ROM control unit 40 supplies the interrupt controller 30 with a ROM memory-error-notice signal (MERR_ROM) and a CPU-access number (ROM_CPU_ID) to ROM 50.

ECC (error correction and detection) errors, and parity errors in data reading from RAM, ROM and the like are referred to as “memory error”. ECC error detection is based on SEC-DED by which single bit error correction and double bit error detection are performed. The parity error detection is based on single bit error detection.

### <Detection of Memory Error>

The detection of a memory error will be described here.

In the CPUs 200 to 203, the detection of a memory error inside the core is performed. In case that such error is detected, a corresponding memory-error-notice signal (MERR0-MERR3) is asserted. Here, the CPU to notify of the memory error is not CPU having made a memory access, but CPU having the memory with the memory error. For instance, in case that an error is caused in data reading from RAM2 in the CPU 200, what notifies the interrupt controller 30 of the error is the CPU 200, and the CPU 200 asserts the corresponding memory-error-notice signal MERR0. The reason why arrangement is made so that the CPU having the memory with a memory error provides notification of the memory error is that it is intended to simplify the processing by restricting the range of hardware control within the CPU concerned e.g. in judging the priority when memory errors on the two or more memories in CPU, i.e. the primary cache (L1C), built-in SRAM1 (RAM1) and built-in SRAM2 (RAM2), are detected at a time, and in processing memory errors on two or more memories.

The duplicated tag memory 211 and secondary cache 212 are shared by the CPUs 200 to 203. Therefore, in case that an error is caused in data reading from the shared memory, the system controller 210 notifies the CPU which has accessed the memory of the memory error, and then the CPU provides a notification of the memory error by means of an interruption on the interrupt controller 30.

### <Occurrence of Memory Error Interruption>

Next, the processing in the event of occurrence of a memory error interruption will be described.

As for the interrupt controller (INTC), priority of the memory error and other factors is judged. If the interruption owing to a memory error is higher in priority than the other interruption, the interrupt controller selects the memory error interruption, and causes a memory error interruption on the CPU (200-203). The interrupt controller (INTC) issues an interruption to each CPU (200-203) on an individual CPU basis. Now, it is noted that the CPU core which has provided notification of the memory error is the same CPU core which receives a memory-error-interrupt signal. In other words, the CPU core which has provided notification of the memory error receives a memory-error-interrupt signal. <Processing by CPU Subjected to a Memory Error Interruption>

Now, the processing by CPU having accepted a memory error interruption will be described.

When the interrupt controller 30 provides notification of a memory error interruption to the CPU (200-203) by a memory-error-interrupt signal (INT0-INT3), under the condition that the error has been detected as a result of data reading from one memory, the CPU concerned selects the memory. However, under the condition that the error has been detected as a result of data reading from more than one memory, the memory of the top priority is selected. Then, in the error-information-holding circuit (EINFO) inside the CPU, the error flag of the selected memory, and the access CPU number and error address relevant to the selected memory, are stored in the corresponding access-CPU-number register (CPUID) and memory-error-address register (ADR) respectively. Incidentally, a memory error interruption is not always accepted by the CPU (200-203) at once. Therefore, the memory-error-detecting circuit (EDET) of each memory has therein means for holding an access CPU number and an error address. Although no special restriction is intended, e.g. a flip-flop may be adopted for the means for holding an error address.

In addition, the arrangement is made so that no direct interruption is required for the CPU (200-203) having made an access to a memory. The reason for this is to simplify the hardware. Specifically, in the case of requiring a direct interruption for the CPU (200-203) having made a memory access, it is necessary to pass the CPU a memory address. Therefore, an increase in the number of CPUs makes larger the number of signal lines for that address lying between the CPUs accordingly. In contrast, the increase in the number of address signal lines between CPUs can be avoided by requiring no direct interruption for the CPU (200-203) having made a memory access.

### <Memory Error Analysis by Means of Software>

Next, the analysis of a memory error by means of software will be described.

If the CPU (200-203) having accepted a memory error interruption conforms to a number stored in the access-CPU-number register, the access is one which has been made in the CPU. Therefore, the memory error address can be found out by executing a predetermined software program on the CPU in question, whereby the memory which has caused the error can be determined. For instance, on condition that data written in the memory contain an ECC code for performing a single bit error correction, read data is corrected by ECC by immediately writing data gained by using a software program to read the memory in question, and therefore the memory cell data can be corrected. In the case of the double bit error detection, it is difficult to correct. In such case, the following means may be adopted, for example: running a failure-analyzing program on CPU; or shifting the operation mode of CPU to its safe mode.

In the case that the number of the CPU (200-203) having accepted an interruption is different from a number stored in the access-CPU-number register, a software program issues an inter-CPU interruption to the CPU core indicated by the access CPU number in order to notify the CPU having made a memory access. In this way, the CPU having made a memory access can recognize the memory on which an error occurs.

The CPU (200-203) having accepted an interruption clears a bit of the memory-error-flag register (ER_FLG) corresponding to the memory on which the CPU has received a notification of a memory error. If other bits hold the logical value “1”, the notification of a memory error will be provided to the interrupt controller in succession. The processing of interruption is performed on an individual error basis. Then, after all the bits are cleared, the processing of a memory error is terminated.

To handle a memory error, the error-detecting circuit (EDET) in each memory is provided with the following four circuits: (1) ECC/parity functioning circuit; (2) a primary holding circuit capable of holding a detection flag (of one bit) when a memory error is detected; (3) a primary holding circuit capable of holding an error address when a notification of a memory error is provided for the first time after the clear of a flag; and (4) a primary holding circuit capable of holding an access CPU number of the CPU having caused a memory error, only for a memory which allows an access by other CPU core.

Each of the primary holding circuits may be constituted by a flip-flop. Although no special restriction is intended, one error address is stored in each memory. Once a flag is set, the error address is not updated until a flag clear signal is asserted. Even if a memory error is caused before clear of the flag, the memory error is ignored.

Each CPU (200-203) has therein an error-information-holding circuit (EINFO). Although no special restriction is intended, the error-information-holding circuit (EINFO) includes an error-flag register (ER_FLG), an error-address register (ADR) and an access-CPU-number register (CPUID) capable of holding the number of CPU having made a memory access resulting in a memory error.

On receipt of a notification of a memory error interruption, the error flag of a memory of the top priority inside the core is set in the memory-error-flag register (ER_FLG), and the error address and CPU number are copied from the error-detecting circuit (EDET)of the relevant memory to the error-address register (ADR) and access-CPU-number register (CPUID) of the error-information-holding circuit (EINFO), respectively.

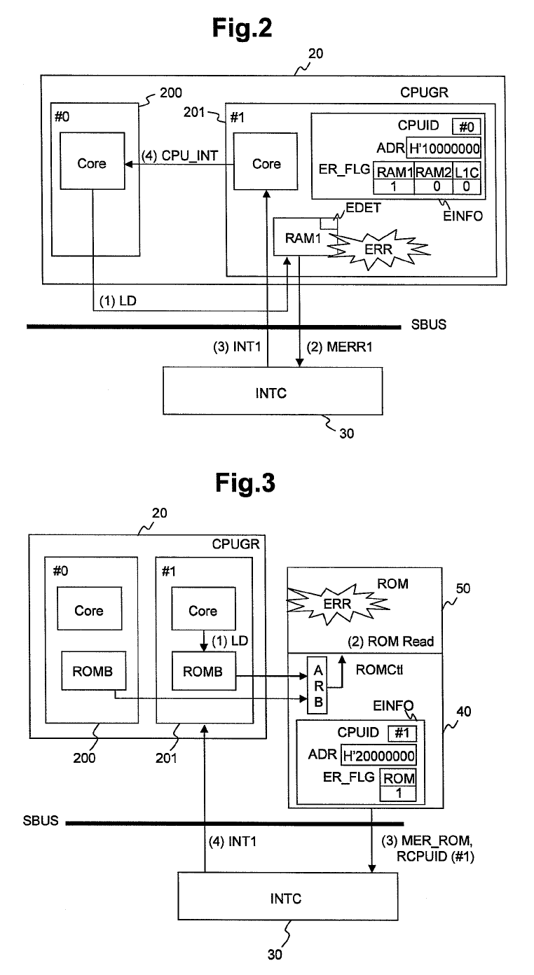

Now, the processing in the case that a memory access by other CPU causes a memory error will be described with reference to FIG. 2.

In the example of FIG. 2, mutually different operating systems work on the CPU 200 and CPU 201, and the Asymmetric Multi-Processing (AMP) process is conducted. In this case, the processing is performed as follows.

It is assumed that a memory error occurs when the CPU 200 reads the RAM1 in the CPU 201. In this case, a notification of a memory error is fed from the CPU 201 to the interrupt controller (INTC) 30 ((2) MERR1). Further, a memory error interruption is caused from the interrupt controller 30 to the CPU 201 ((3) INT1).

As information of RAM1, an error address of H'10000000 is held in the memory-error-address register (ADR), and a CPU number (#0) is kept in the memory-access-CPU-number register (CPUID).

Then, an interruption handler of the CPU 201 performs a proper processing. The memory-access-CPU-number register (CPUID) is read, and then an inter-CPU interruption to the CPU 200 is caused by the software program because the CPU number is #0, whereby the CPU 200 is notified of the memory error. If the CPU having accepted the interruption is not the one which the CPU number of the CPU having made the access indicates, the software causes an inter-CPU interruption to the CPU corresponding to the CPU number in order to notify the CPU having made the access. In this way, the CPU having made the access can be notified of the memory causing the error. In the case that mutually different operating systems work on the CPU having accepted such interruption and the CPU having made the access, it is necessary to explicitly notify the CPU involved in the access in order to allow the CPU involved in the access to appropriately handle a one-bit error and a two-bit error. In this case, a software interruption is performed from the CPU 201 to the CPU 200.

Next, the processing of a memory error caused in access to ROM shared by the CPUs will be described, provided that mutually different operating systems work on the CPU 200 and CPU 201, and the Asymmetric Multi-Processing (AMP) process is conducted.

FIG. 3 shows an example in which a memory error is caused by the CPU 201 making a memory access to ROM.

In the CPU 201, a load is performed from the CPU core (Core) to the ROM buffer (ROMB) ((1) LD). However, actually the ROM buffer (ROMB) is missed, and a read is performed on ROM ((2) ROM Reed). Then, a memory error occurs on the ROM ((3) MER_ROM, RCPUID). Then, the ROM control unit (ROMCtl) 40 provides the interrupt controller (INTC) 30 with a notification of the CPU 201 as a memory error (ROM_MERR) and a CPU_ID. The interrupt controller (INTC) 30 causes a memory error interruption to the CPU 201 ((4) INT1).

This is the processing of a memory error at an access to a shared memory. On receipt of CPU_ID from the ROM, the interrupt controller (INTC) can set CPU for providing a notification of an interruption dynamically. It is not particularly restricted whether to have the error information of the ROM in the ROM controller 40 or in the CPU. In the case of having the error information in the CPU, a control line extending to a distance ends up being laid down. Hence, in this example, the ROM controller ROMCtl is arranged to have the error information of the ROM therein.

Next, the processing of a memory error in connection with a cache coherency function referred to as “snoop cache” when the Symmetric Multi-Processing (SMP) process is performed on condition that the same operating system works on the CPUs 200 to 203 will be described.

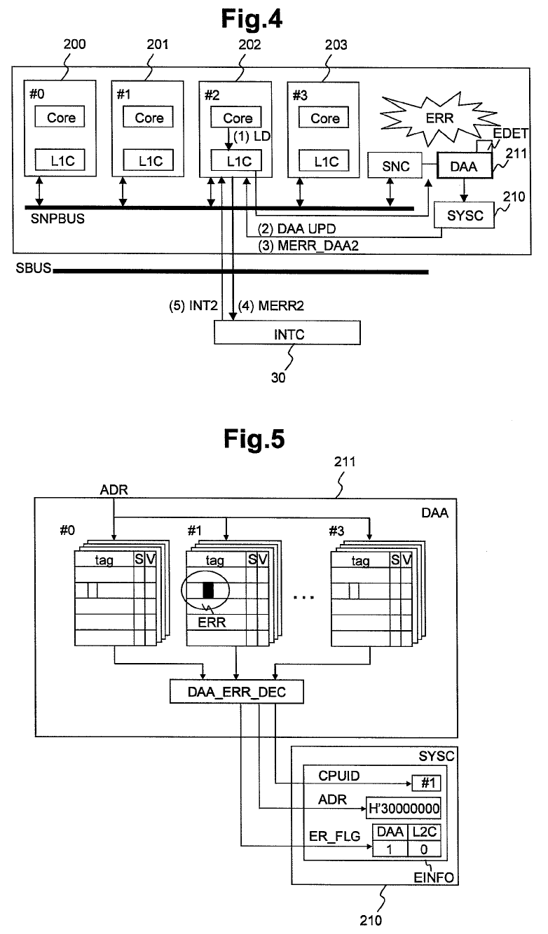

FIG. 4 shows an example in which a memory error occurs on the CPU 202 of a duplicated tag in the microprocessor with the cache coherency treated therein.

In the CPU 202, data of the primary cache (L1C) is loaded ((1) LD). Subsequently, with the CPUs 200 to 203, the duplicated tag memory (DAA) 211 having copies of tags of the primary caches is updated ((2) DAA UPD). This is because to make the latest data available when respective caches are required in the cache snooping. When a memory error occurs on the duplicated tag memory (DAA) 211, a notification of a memory error is provided from the system controller (SYSC) to the CPU 202 through the snoop cache (SNC) ((3) MERR_DAA2). Further, a notification of a memory error interruption is provided from the CPU 202 to the interrupt controller (INTO) 30 ((4) MERR2). A memory error interruption is issued from the interrupt controller (TNTC) 30 to the CPU 202 ((5) INT2).

As described above, in the system supporting a coherent cache, the flag bit of the duplicated tag memory 211, the CPU number (CPUID), and the tag address of the primary cache as an error address (ADR) are held by the error-information-holding circuit (EINFO) in the CPU 202 at the occurrence of a memory error on the duplicated tag memory (DAA) 211. The software program treats the error as a memory error on the primary cache of the CPU concerned, and it clears an effective bit thereby to perform the nullification.

FIG. 5 shows an example of the configuration of the duplicated tag memory (DAA) 211.

The duplicated tag memory (DAA) 211 has tag information of the primary cache included in each of the CPUs 200 to 203. As to the four CPUs, FIG. 5 presents an example in which the primary cache of each CPU core takes a four-way structure. In the drawing, the S bit is a shared bit, which is in a shared condition, and the V bit is an effective bit. The error-information-holding circuit (EINFO) in the system controller 210 is provided with a memory-error-flag register (ER_FLG), a memory-error-address register (ADR), and an access-CPU-number register (CPUID) of the duplicated tag memory (DAA) 211.

With reference to FIG. 5, the case of occurrence of a soft error (ERR) of a memory will be described.

A soft error owing to cosmic radiation and the like tends to concentrate in some narrow areas. Here, it is supposed as an example the situation that cosmic rays impinge on a portion of an array in a duplicated tag memory, which corresponds to the CPU number #1. Arrays corresponding to other CPUs are located physically away from the array of interest, and therefore the possibility that the cosmic rays would strike the arrays concurrently thereby causing a soft error is extremely low. On this account, it is suffice to consider only a part of cosmic radiation corresponding to one CPU. Further, as to a memory array, the measure of widening the distance between bits constituting the data may be taken to reduce the probability of occurrence of an error of two bits or larger in regard to a piece of data. In the error-information-holding circuit (EINFO) of the system controller 210, one (1) is set on a DAA bit in the memory-error-flag register (ER_FLG). Further, in the memory-error-address register (ADR), the tag address of the primary cache corresponding to a portion where a memory error has occurred is stored, and the CPU number #1 in DAA is stored in the access-CPU-number register (CPUID). The CPU having accepted a memory error interruption treats the error as a memory error in the primary cache of CPU1, and uses the software to clear an effective bit of the tag address (H'30000000) of the primary cache in question thereby to perform the nullification.

Next, the processing of a memory error in the case that mutually different operating systems work mixedly will be described. Specifically, it is assumed here that Symmetric Multi-Processing (SMP) is adopted for the CPUs 200 to 202, and Asymmetric Multi-Processing (AMP) is for the CPU 203.

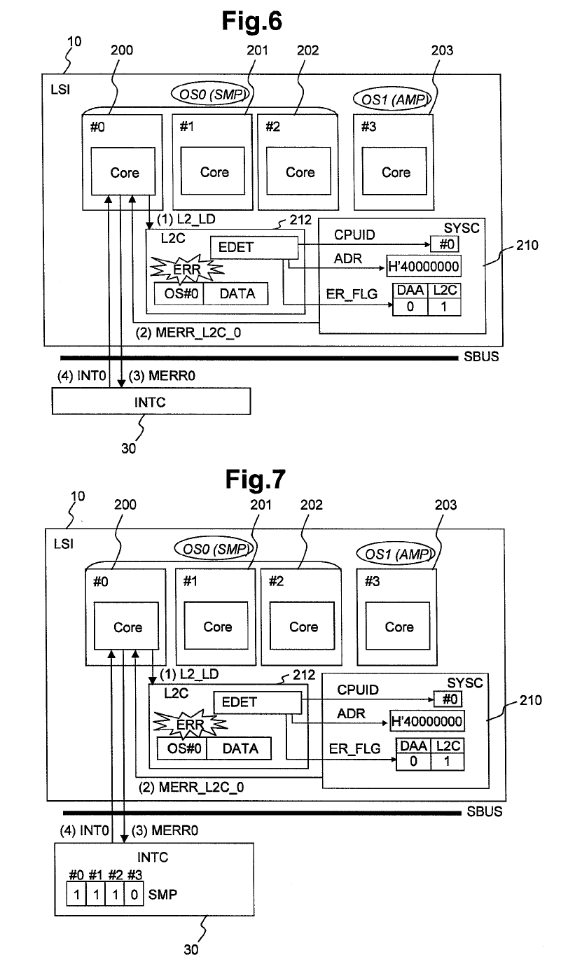

FIG. 6 shows an example in which a memory error occurs on condition that mutually different operating systems work for SMP and AMP respectively is shown with reference to FIG. 6. The operating system OS0 works on the CPUs 200 to 202 according to Symmetric Multi-Processing (SMP), and the operating system OS1 works on the CPU 203.

It is assumed that a memory error occurs when the CPU 200 reads the L2 cache 212. The system controller 210 sets a bit of the L2 cache 212 of the memory-error-flag register (ER_FLG), stores “H'40000000” in the memory-error-address register (ADR), and puts “#0” in the access-CPU-number register (CPUID).

Next, the system controller 210 notifies the CPU 200 of the memory error ((2) MERR_L2C_0). The CPU 200 notifies the interrupt controller 30 of the memory error ((3) MERR_0). Thus, the interrupt controller 30 causes a memory error interruption to the CPU 200 ((4) INT0).

As described above, when a memory error occurs on a shared memory such as the L2 cache 212 with more than one operating system running on the multiprocessor, an interruption is performed on the access-source CPU. The reasons for making this arrangement are: only operating systems identical in entries can access the L2 cache 212; and only the access-source CPU is allowed to nullify an entry.

In regard to CPUs working on a common operating system according to Symmetric Multi-Processing (SMP), the following are possible: to access an entry on which a memory error has occurs; and to nullify an entry. Therefore, the modification as shown in FIG. 7 may be made. For instance, in the example of FIG. 6, the microprocessor according to the invention is arranged to determine the access-source CPU at the occurrence of a memory error, and to notify the CPU concerned of the memory error even if the CPUs 200, 201 and 202 are operable to perform an action common to them according to Symmetric Multi-Processing (SMP). However, in the example shown by FIG. 7, the CPUs 200, 201 and 202 working on a common operating system are treated as one group, and the CPU which performs, as an access-source CPU, the processing of interruption in connection with a memory error is the one belonging to the group. Specifically, on condition that an access by the CPU 200 has caused a memory error, the CPU 200 notifies the interrupt controller of the memory error, and then the interrupt controller notifies the CPUs 200, 201 and 202 operating according to SMP of the memory error interruption at once, a CPU which receives a memory error first is decided as the CPU subjected to a memory error interruption. At this time, by newly setting a flag showing, of the CPUs, the one working on the common operating system in the interrupt controller, it becomes possible to judge the CPUs to notify of a memory error interruption in parallel.

According to the embodiments, the following effects and advantages can be gained.

(1) The microprocessor has: a plurality of CPUs 200 to 203 each accessible to a primary cache (L1C), a built-in SRAM1 (RAM1) and a built-in SRAM2 (RAM2); and an error-information-holding circuit (EINFO) operable to store CPU-identifying information which enables identification of the CPU having accessed the memory. In addition, stored information in the error-information-holding circuit (EINFO) is used to perform an error processing to cope with a soft error on the memories, whereby a memory error on built-in memories such as the primary cache (L1C), built-in SRAM1 (RAM1) and built-in SRAM2 (RAM2) can be processed on condition that more than one operating system supporting Asymmetric Multi-Processing (AMP) works on the CPUs.

(2) The microprocessor can be provided with a ROM 50 shared by the CPUs 200 to 203, and a ROM control unit 40 operable to control the ROM. The ROM control unit 40 can be provided with an error-information-holding circuit (EINFO) operable to hold: an address where a soft error of the memory occurs; and the CPU number of the CPU making an access to the shared memory at the time of occurrence of a soft error of the shared memory. In this case, the interrupt controller 30 may be arranged so that when notified from the control circuit of a result of detection of a soft error of the shared memory, and identification information of CPU involved with memory access, the interrupt controller issues a soft error interruption of the memory to the CPU corresponding to the relevant identification information. As a result, it is possible to execute a memory error processing on ROM 50 forming a shared memory in the case that more than one operating system supporting Asymmetric Multi-Processing (AMP) works.

(3) The CPUs 200 to 203 each have a primary cache (L1C) provided therein. Further, the microprocessor 10 has a duplicated tag memory 211 for storing a copy of a tag of the primary cache. The duplicated tag memory 211 can be updated at the time of accessing the primary cache (L1C). When a memory error occurs on the duplicated tag memory 211, a CPU number, which enables identification of CPU involved with access to the primary cache (L1C), tag information of the primary cache (L1C), and a flag bit corresponding to the duplicated tag memory 211 are set in the error-information-holding circuit (EINFO) in CPU, which is for controlling the primary cache (L1C). Thus, with an operating system supporting Symmetric Multi-Processing (SMP), an error processing of a memory particularly in connection with a cache coherency function, referred to as “snoop cache” can be performed.

(4) The microprocessor 10 is provided with a secondary cache (L2C), and a system controller 210 capable of controlling the secondary cache. The system controller 210 is provided with an error-information-holding circuit (EINFO) which is capable of holding an address where a soft error of a memory concerned occurs, and identification information of CPU having accessed the memory in case of occurrence of the soft error of the memory. When notified of a result of detection of a soft error of the secondary cache and identification information of CPU involved with access to the secondary cache, the interrupt controller issues a soft error interruption in connection with the memory to the CPU corresponding to the CPU identification information. Thus, a memory error of a secondary cache used as a shared memory can be processed in a microprocessor such that operating systems supporting Asymmetric Multi-Processing (AMP) and Symmetric Multi-Processing (SMP) work mixedly.

While the invention made by the inventor has been described above based on the embodiments specifically, it is not so limited. It should be appreciated that various changes and modifications may be made without departing from the scope of the invention.

The invention is also applicable to e.g. a microprocessor having a plurality of CPUs and a plurality of memories, and working on a plurality of operating systems.

What is claimed is:

1. A data processor comprising:
a plurality of CPUs;
a first storing unit; and
first storing unit,
wherein the plurality of CPUs are each capable of accessing a memory,
the first storing unit is capable of storing CPU-identifying information which enables identification of the CPU having accessed the memory, and
an error processing to cope with a soft error on the memory is performed by use of stored information of the first storing unit.

2. The data processor according to claim 1, further comprising:
an interrupt controller operable to accept an error notification corresponding to the soft error, and to assert an interrupt signal according to a predetermined priority order,
wherein information of an address where the soft error of the memory concerned occurs is stored in the first storing unit when the CPU receives an interruption resulting from the soft error on the memory from the interrupt controller.

3. The data processor according to claim 2, wherein the interrupt controller includes a function of inter-CPU interruption according to software setting,
when identification information of the CPU controlling the memory differs from the CPU-identifying information stored in the first storing unit, the interrupt controller issues an inter-CPU interruption, thereby to notify the CPU corresponding to the CPU-identifying information stored in the first storing unit of occurrence of the soft error of the memory.

4. The data processor according to claim 2, further comprising:
a shared memory shared by the plurality of CPUs; and
a control circuit capable of controlling the shared memory in operation,
wherein the control circuit includes a second storing unit capable of holding an address where the soft error of the memory occurs, and identification information of the CPU having accessed the shared memory in case of occurrence of a soft error of the shared memory, and
when notified from the control circuit of a result of detection of a soft error of the shared memory, and identification information of the CPU involved with memory access, the interrupt controller issues a soft error interruption of the memory to the CPU corresponding to the relevant identification information.

5. The data processor according to claim 2, further comprising:
a duplicated tag memory,
wherein the plurality of CPUs each include a primary cache,
the duplicated tag memory is capable of storing a copy of a tag of the primary cache,
the duplicated tag memory can be updated when an access to the primary cache is made, and
identification information of the CPU involved with access to the primary cache, tag information of the primary cache, and a flag bit corresponding the duplicated memory are set in the first storing unit in the CPU operable to control the primary cache in case of occurrence of a memory error on the duplicated tag memory.

6. The data processor according to claim 2, further comprising:
a secondary cache; and
a control circuit capable of controlling the secondary cache,
wherein the secondary cache control circuit includes a third storing unit capable of holding an address where a soft error of the memory concerned occurs, and identification information of the CPU having accessed the memory in case of occurrence of a soft error of the memory, and
when notified of a result of detection of a soft error of the secondary cache, and identification information of the CPU involved with access to the secondary cache, the interrupt controller issues a soft error interruption of the memory to the CPU corresponding to the CPU identification information.

7. The data processor according to claim 2, further comprising:
a secondary cache; and
a control circuit capable of controlling the secondary cache,
wherein the secondary cache control circuit includes a third storing unit capable of holding an address where a soft error of the memory concerned occurs, and identification information of the CPU having accessed the memory in case of occurrence of a soft error of the memory, and
at least two of the plurality of CPUs are identical to each other in operating system on which the at least two CPUs work according to Symmetric Multi-Processing, and
in case of occurrence of a soft error owing to access to the secondary cache by one of the at least two CPUs, the interrupt controller issues a soft error interruption of the memory to the at least two CPUs all at once, on receipt of notification of a result of detection of a soft error of the secondary cache, and identification information of the CPU involved with access to the secondary cache.
